(19) United States
(12) Patent Application Publication
(10) Pub. No.: US 2006/0068777 A1
(43) Pub. Date: Mar. 30, 2006

(54) Air interface cooperation between WWAN and WLAN

(76) Inventors: John S. Sadowsky, Mesa, AZ (US); Ernest E. Woodward, Chandler, AZ (US)

Correspondence Address: INTEL CORPORATION, P.O. BOX 5326, SANTA CLARA, CA, 95056-5326, US

(21) Appl. No.: 10/883,611

(22) Filed: Jun. 30, 2004

(51) Int. Cl. H04Q 7/20

(52) U.S. Cl. 455/427

(57) ABSTRACT

Methods and systems for communicating in a wireless network include usage based switching between two or more different types of air interfaces. In example implementations, a first air interface for wireless wide area networks (WWAN) may be used for low bandwidth data transfers and a second interface for wireless local area networks (WLAN) or wireless metropolitan area networks (WMAN) may be used for higher bandwidth data transfers. Various specific embodiments and variations are also disclosed.

### BACKGROUND OF THE INVENTION

Due to the increasing use of wireless networks for media applications, it is becoming more important to be able to provide service with greater efficiency while still maintaining low power consumption for mobile devices. Currently, there are several types of wireless networks each having unique aspects. For example, there are various types of air interfaces for wireless wide area networks (WWANs) and wireless local area networks (WLANs). Air interfaces for these types of networks may have various advantageous and disadvantages.

Accordingly, it would be desirable for wireless networks to utilize at least two different air interfaces in a manner to increase efficiency of wireless communications.

### BRIEF DESCRIPTION OF THE DRAWING

Aspects, features and advantages of the embodiments of the present invention will become apparent from the following description of the invention in reference to the appended drawing in which like numerals denote like elements and in which:

FIG. 1 is a block diagram of a wireless network according to one example embodiment of the present invention;

FIG. 2 is a functional block diagram showing an example wireless network communicating using a first air interface of a multiple air interface system according to one embodiment of the present invention;

FIG. 3 is a functional block diagram showing an example wireless network communicating using a first and second air interface of the multiple air interface system according to one embodiment of the present invention;

FIG. 4 is a flow diagram of an example method for content based switching of air interfaces in a wireless network according to various embodiments of the present invention; and

FIG. 5 is a functional block diagram of an example embodiment for a wireless apparatus adapted to perform one or more of the methods of the present invention.

### DETAILED DESCRIPTION OF THE INVENTION

While the following detailed description may describe example embodiments of the present invention in relation to air interfaces for wireless local area networks (WLANs) and wireless wide area networks (WWANs), the invention is not limited thereto and can be applied to other types of wireless networks or air interfaces where advantages could be obtained. Such air interfaces specifically include, but are not limited to, those associated with wireless metropolitan area networks (WMANs), such as wireless broadband solutions colloquially referred to as wireless to the max (WiMAX) air interfaces and wireless personal area networks (WPANs) and the like.

The following inventive embodiments may be used in a variety of applications including transmitters and receivers of a radio system, although the present invention is not limited in this respect. Radio systems specifically included within the scope of the present invention include, but are not limited to, network interface cards (NICs), network adaptors, mobile stations, base stations, access points (APs), gateways, bridges, hubs and radiotelephones. Further, the radio systems within the scope of the invention may include cellular radiotelephone systems, satellite systems, personal communication systems (PCS), two-way radio systems, two-way pagers, personal computers (PCs) and related peripherals, personal digital assistants (PDAs), personal computing accessories and all existing and future arising systems which may be related in nature and to which the principles of the inventive embodiments could be suitably applied.

As used herein, WWANs may include but are not limited to packet data cellular networks such as general packet radio service (GPRS), enhanced GPRS (EGPRS), wideband code division multiple access (WCDMA), cdma2000, or other similar systems or air interfaces which may cover metropolitan-size or broader geographic areas. Certain advantages of WWANs include a relatively broad area of coverage coupled with relatively low power consumption. The low power consumption often results from using highly scheduled transmission protocols. For example, packet data services may be managed in a WWAN using a paging system. Paging channels may be scheduled for each mobile user using a low duty cycle. This allows a mobile receiver to essentially “sleep” between paging channels. When data traffic arrives, the system may move from the paging mode to an active mode to receive dedicated data packets. A disadvantage of many WWANs is a relatively low data throughput on the order of 150 kps.

By contrast, WLANs have a relatively large data throughput and can sustain bursty transmissions on the order of 11-54 Mbps. However, since many WLANs use carrier sense multiple access (CSMA) or similar traffic delivery protocols, a WLAN receiver may constantly monitor the channel and demodulate at least part of all transmissions in order to detect which transmissions are addressed specifically to the receiver. This constant monitoring may result in higher power consumption as compared with WWANs. The table below illustrates some advantages and disadvantages of these systems:

TABLE 1

| | WLAN | WWAN |
|---|---|---|
| Coverage | Highly limited - (home, | Metropolitan area or broader |
| | business + hotspots). By area, | coverage. |
| | WLAN coverage is insignificant | |
| | in comparison to WWAN. | |
| Throughput | Extremely high. WiFi (Institute | Limited. In reality, one can rely |
| | for Electrical and Electronics | on rates on the order of 144 kbps. |
| | Engineers (IEEE) 802.11a | These systems will |
| | standard for WLAN) bursts at 11 Mbps. | support higher rates, but with |
| | IEEE 802.11g bursts at | limited coverage. Systems like |
| | 54 Mbps. | high speed downlink packet |
| | | access (HSDPA) will provide up |
| | | to 10 Mbps burst rates, but only |
| | | for limited coverage and these |
| | | services are not available yet. |
| Scheduling | Essentially none. CSMA | Highly scheduled. Packet data |
| | (carrier sense multiple access) | services are managed using a |
| | is essentially an “Ethernet on | paging system. Paging |
| | the air.” | channels are scheduled per |
| | | user with a very low duty factor. |
| | | This allows the mobile receiver |
| | | to “sleep” between paging |
| | | systems. When data traffic |
| | | arrives, the system moves from |
| | | the paging mode to an active |
| | | mode to receive dedicated data |
| | | packets. |
| Power | High. CSMA requires that the | Very low. The paging system |
| Consumption | receiver constantly monitor the | allows very low power sleep |
| | channel and demodulate at | periods between traffic bursts. |
| | least part of all transmission to | In active mode, the mobile fully |
| | detect which transmission are | demodulates only packets |
| | addressed to the specific user. | addressed to that mobile. |

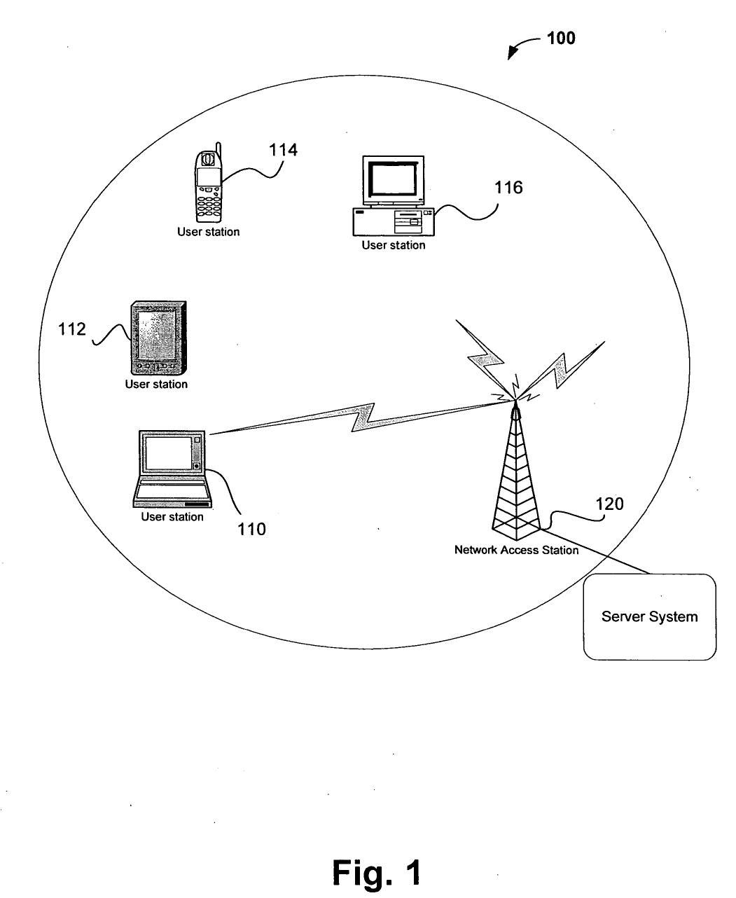

Turning to FIG. 1, a wireless communication system 100 according to one embodiment of the invention may include one or more user stations 110, 112, 114, 116 and one or more network access stations 120. System 100 may be capable of facilitating two or more different types of air interfaces such as an air interface for WLAN networks, an air interface for WWAN networks and an air interface for WMAN networks. One or more user stations 110-116 may communicate with one or more network access stations 120 via the different air interfaces based on bandwidth requirements or power efficiencies for various communications.

System 100 may further include one or more other wired or wireless network devices as desired. In certain embodiments system 100 may use an adaptive orthogonal frequency division multiplexing (OFDM) air interface although the embodiments of the invention are not limited in this respect. OFDM is the modulation currently used in many wireless applications including the Institute of Electrical and Electronic Engineers (IEEE) 802.11 (a) and (g) standards for WLANs.

Peers in a wireless network such as user stations 110, 112, 114 and 116 may have varying needs for supporting traffic streams or data transfers. Accordingly in one example implementation, user stations 110-116 and network access station 120 may utilize a WWAN air interface and a WLAN air interface in combination to achieve enhanced data transfers and/or greater power efficiency. In another example. implementation, the peers may utilize a WWAN air interface and a WMAN air interface in combination.

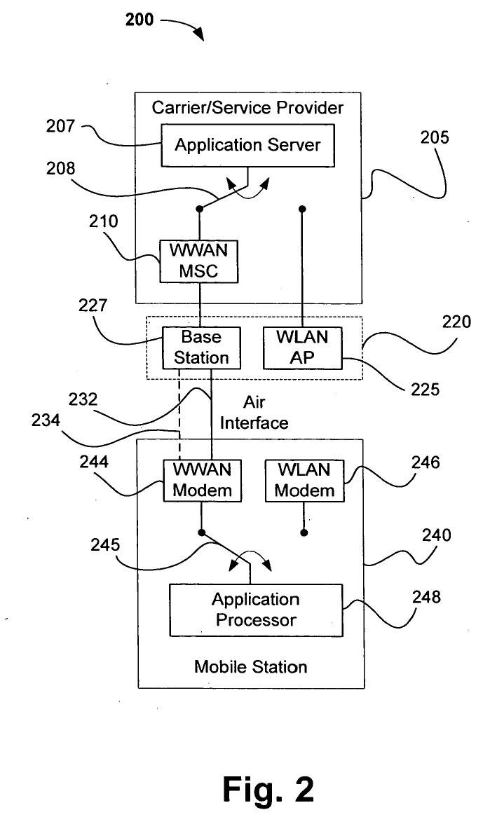

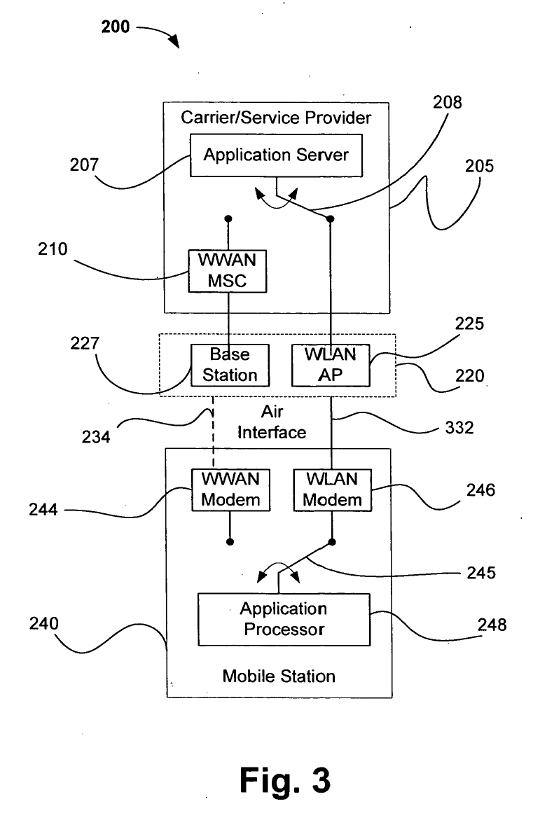

Turning to FIGS. 2 and 3, an example architecture for a network 200 adapted for usage based switching of multiple air interfaces generally includes a server system 205, one or more distribution stations 220 and one or more clients 240.

Server system 205 may be any component or combination of components adapted to provide information to, and/or facilitate communications with, one or more clients (e.g., client 240; user stations 110-116, FIG. 1). In certain example implementations, server system 205 may provide functionality of an application program server 207 as well as a WWAN mobile switching center (MSC) 210, although the inventive embodiments are not limited in this respect.

Distribution station 220 may be any individual station or combination of stations adapted to support one or more air interfaces. In certain embodiments, distribution station 220 may include functionality for supporting a WLAN air interface (e.g., WLAN access point (AP) 225) and a WWAN air interface (e.g., base station 227). Distribution station 220 may be separate from or included with server system 205 as suitably desired.

Client 240 may be any mobile or stationary device or combination of devices configured to receive data from server station 205 via an air interface. Client 240 may include any radio frequency (RF), physical (PHY) link layer and/or data link layer components adapted to support multiple air interfaces. In one example embodiment, client 240 may support connection via a WWAN air interface as well as a WLAN air interface. Client 240 may include respective functional components generally depicted as WWAN modem 244 and WLAN modem 246. Client 240 may also include one or more processors 248 and/or memories (not shown) for supporting various application programs on client 240.

In one embodiment, there may be at least two modes of data transmission; for example, a WWAN mode (shown enabled in the illustrative embodiment of FIG. 2) and a WLAN mode (shown enabled in the illustrative embodiment of FIG. 3). According to one possible implementation, application server 207 may dynamically switch between WWAN mode and WLAN mode operations based on the content or amount of data to be transferred to/from client 240. Additionally or alternatively, switching between various modes may be based on a quality of service (QoS) requirement or desire so that switching between various air interfaces may be performed, for example, based on cost, link error, latency, synchronized path or isochronous path preferences.

Application server 207 and/or application processor 248 may utilize respective data paths 208, 245 to select the desired air interface (e.g., WWAN air interface 232 or WLAN air interface 332) for primary data transfers. FIGS. 2 and 3 show that the logical pipe of packet communications between WWAN mode and WLAN mode may be established by holding emphasis on the WWAN modem 244 to base station 227 interface for WWAN mode (FIG. 2) and holding emphasis on the WLAN modem 246 and AP 225 interface for WLAN mode (FIG. 3). The main packet throughput may be moved between WWAN modem 244 and WLAN modem 246 based on operational desires. In preferred embodiments, regardless of which data path 208, 245 (FIG. 2; FIG. 3) or corresponding air interface 232, 332 is used for primary packet throughput, a radio control link 234 with the WWAN is maintained.

Radio control link 234 may be a paging channel used for tracking WWAN connections with base stations. WWAN paging channels are used by base stations to periodically send low bandwidth messages to generally inform mobile stations of network activity (e.g., they can wake up mobile stations or allow them to continue in a sleep mode). Mobile stations may also respond via the paging channel so that a base station may monitor which mobile stations are in its area of coverage. Accordingly, in various embodiments of the present invention, switching between WWAN mode and WLAN mode for data transfers is not a hard handoff to the WLAN AP 220 because the paging channel for the WWAN air interface is not released even when in WLAN mode.

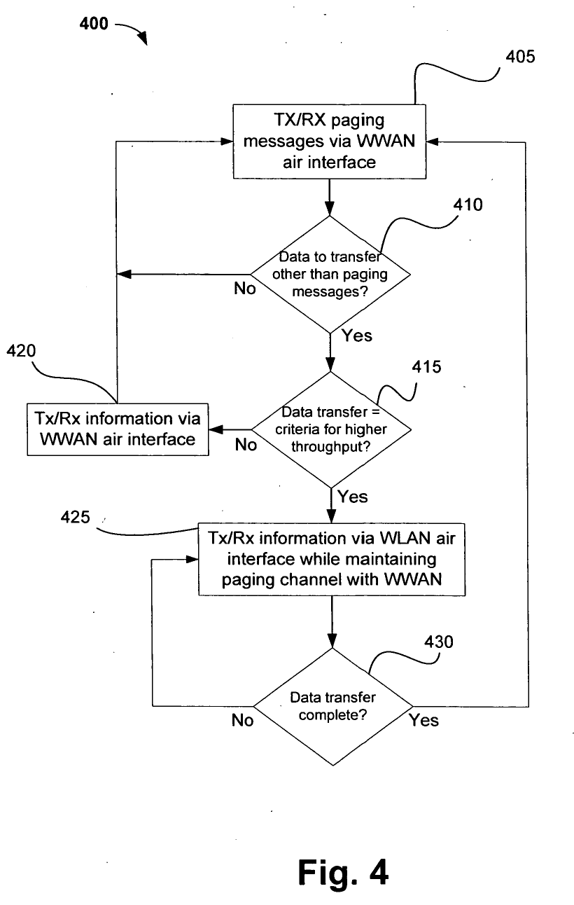

Turning now to FIG. 4, an example method 400 for content-based or usage-based switching between an air interface (e.g. a WWAN) and a higher throughput air interface (e.g., a WLAN or WMAN) generally may include transmitting or receiving 405, 420 first information using a first air interface and transmitting or receiving 425 second information using a second air interface different than the first interface while maintaining connection with the first air interface.

In certain embodiments, a wireless device (e.g., client 240; FIGS. 2 and 3) may transmit and/or receive 405 one or more messages over a paging channel with a network station (e.g., 227; FIGS. 2 and 3) via a WWAN air interface. Such interface may include, for example, an (E)GPRS, WCDMA, CDMA 2000 or other type of packet data cellular air interface. If 410 there is data to be transferred to or from the wireless device, characteristics of the data to be transferred and/or network may be evaluated 415.

One or more criteria may be used for determining which type of air interface should be used for data transfer. These criteria may include, but are not limited to: (i) whether more than one type of air interface is possible (e.g., whether the client device has access to multiple air interfaces in its present location); (ii) what type of data is to be transferred (e.g., time-sensitive or integrity sensitive data); (iii) available power for the client device; (iv) a volume and/or suitable data rate of the data to be transferred; (v) a quality of service (QoS) required or desired; or (vi) any combination of the foregoing criteria. Decisions based on the criteria may be made by the client device (e.g., application processor 245), a network management entity (e.g., application server 207) and/or a combination of both.

If 415 the predetermined criteria for using a higher throughput air interface are not met, data may be transferred 420 to or from the wireless device using the lower throughput air interface (e.g., WWAN interface). If 415 however, one or more of the criteria for using the higher throughput air interface are met, data may be transferred 425 to or from the wireless device using the higher throughput air interface (e.g., WLAN air interface or WiMAX air interface) while the paging channel with the lower throughput network is maintained.

When 430, the higher throughput data transfer is completed, the wireless device and/or network station may revert to communications via the lower throughput air interface (e.g., 405 and/or 420). The various embodiments of the present invention are ideally suited for applications which often involve bursty data transfers such as web browsing, file transfer protocol (FTP) transfers, distribution of digital images (e.g., digital camera photos), emails or similar applications.

For example, traffic flow for web applications may include lots of short messages (e.g., transfer control protocol/Internet protocol (TCP/IP) acknowledgements (ACKs), keystroke messages and the like). Consequently, with a fairly low duty factor a wireless device can transmit or receive fairly large files. However, there are likewise, many long idle periods for these types of applications which make constant monitoring, e.g., with a carrier sense multiple access (CSMA) air interface, inefficient for power consumption purposes.

In one example implementation, consider a mobile device (e.g., client 240; FIGS. 2 and 3) communicating with a network via a WWAN air interface such as used by a general packet radio system (GPRS). In this example, the mobile device may be running a web browser application which needs to download a new web page. To do this, the mobile device may first initiate a GPRS transfer block flow (TBF) via the WWAN interface that sends data, which may include a web address of the desire web page, to a network server (e.g., application server 207; FIG. 2).

The mobile device and/or the network access station may determine that the requested download would be best served via a higher throughput air interface (e.g., a WLAN link). Negotiations for the higher throughput air interface may be communicated via the GPRS TBF and subsequently result in the mobile device connecting via the higher throughput air interface (e.g., the mobile device connects to the local AP via the WLAN to establish the WLAN link with the application server). Similarly, a high bandwidth transmit might utilize the WLAN link if, for example the mobile device is attempting to upload a large file (e.g., digital image) to the network. Other varying bandwidth applications may also be possible and the embodiments of the present invention are not limited to any particular air interface or application.

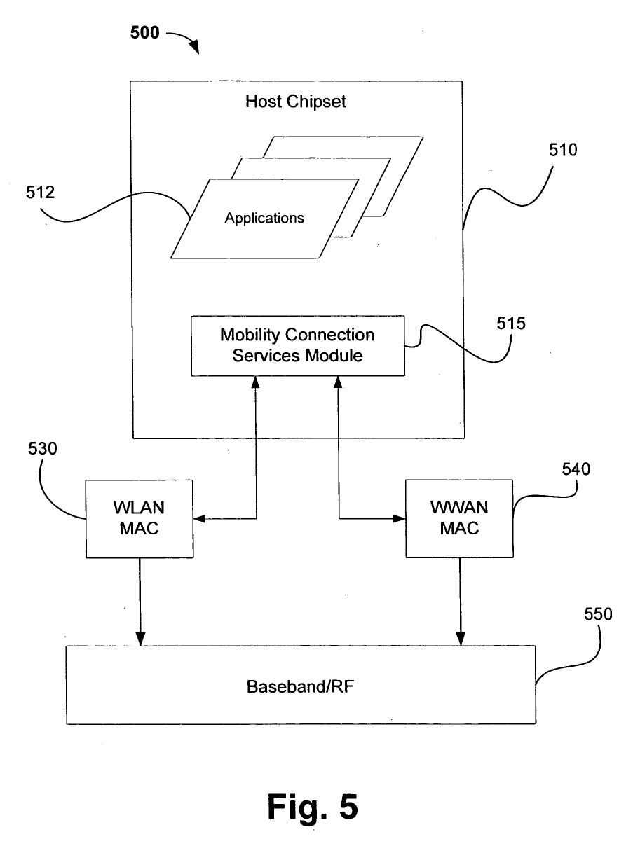

Turning to FIG. 5, an example wireless network apparatus 500 which may be used to implement various embodiments of the present invention may generally include a host processing circuit 510, a WLAN or WMAN medium access controller (MAC) 530, a WWAN MAC 540 and, if desired, a baseband processor and radio frequency (RF) interface 550.

In one example embodiment, host processing circuit 510 may be any component or combination of components and/or machine readable code adapted to process application programs and control or negotiate selection of multiple air interfaces. Circuit 510 may include one or more memories and/or processors (not shown) operative to store and execute application programs 512 such as web browsers, email clients, digital photo applications, personal calendars and the like. Host circuit 510 preferably includes software or a firmware module for controlling or negotiating the data path and/or the active air interface via the respective WLAN MAC 530 or WWAN MAC 540. This functionality is depicted in FIG. 5 as a mobility connection services module 515 which may be a reconfigurable radio architecture programmed to adapt the radio interface as desired.

Baseband/RF portion 550 may include any hardware, software and/or firmware components necessary for physical (PHY) link layer processing and/or RF processing of respective receive/transmit signals for supporting the various air interfaces.

Apparatus 500 may be a wireless mobile station (STA) such as a cell phone, personal digital assistant, computer, personal entertainment device, wireless router or other equipment and/or wireless network adaptor therefore. Accordingly, the functions and/or specific configurations of apparatus 500 could be varied as suitably desired.

The components and features of apparatus 500 may be implemented using any combination of discrete circuitry, application specific integrated circuits (ASICs), logic gates and/or single chip architectures. Further, the features of apparatus 500 may be implemented using microcontrollers, programmable logic arrays and/or microprocessors or any combination of the foregoing where suitably appropriate.

It should be appreciated that apparatus 500 shown in the block diagram of FIG. 5 is only one functionally descriptive example of many potential implementations. Accordingly, division, omission or inclusion of block functions depicted in the accompanying figures does not infer that the hardware components, circuits, software and/or elements for implementing these functions would necessarily be combined, divided, omitted, or included in embodiments of the present invention.

Embodiments of the present invention may be implemented using single input single output (SISO) systems. However, certain alternative implementations may use multiple input multiple output (MIMO) architectures having multiple antennas.

The embodiments of the present invention may result in issues of possible simultaneous radio use (i.e., paging messages transferred via the WWAN air interface while transferring data using the WLAN air interface). One option to handle potential simultaneous radio issues is to have both WLAN and WWAN radios operating simultaneously in the mobile device when in WLAN mode. However, this may be difficult due to interference and other RF implementation issues. In addition, in a reconfigurable radio, resources for both WLAN and WWAN modems (e.g., 246, 244; FIGS. 2 and 3) may not be available for use at the same time. Accordingly, it may be desirable to prevent transmission or reception via the WLAN air interface during WWAN pages.

Additionally or alternatively, when in WLAN mode, the network access station and/or mobile device could refrain from sending or receiving any WWAN traffic. Thus WWAN paging messages (e.g., wake up messages) might not be sent while the mobile device is in WLAN mode or the mobile device could temporarily ignore the WWAN paging channel.

In some instances, the radio resource control (RRC) of a WWAN may send messages to mobile devices even when there is no traffic flow on the WWAN. It is possible if these RRC messages are ignored (e.g., while the mobile device is in WLAN mode), the WWAN link could be incidentally dropped. Potential solutions to address this possibility may be to update the service provider RRC protocols to prevent dropping of the WWAN link or to send the RRC messages over the WLAN link instead. Various solutions to implementation issues may be addressed, in most instances, by updating the existing service provider software.

Unless contrary to physical possibility, the inventors envision the methods described herein: (i) may be performed in any sequence and/or in any combination; and (ii) the components of respective embodiments may be combined in any manner.

Although there have been described example embodiments of this novel invention, many variations and modifications are possible without departing from the scope of the invention. Accordingly the inventive embodiments are not limited by the specific disclosure above, but rather should be limited only by the scope of the appended claims and their legal equivalents.

The invention claimed is:

1. A method of communicating with a wireless device using two air interfaces, the method comprising:
transmitting or receiving first information at the wireless device using a first air interface; and
transmitting or receiving second information at the wireless device using a second air interface different than the first interface while maintaining connection with the first air interface.

2. The method of claim 1 further comprising selecting the first or second air interface based on an amount of information to be transmitted or received.

3. The method of claim 1 wherein the first air interface comprises a wireless wide area network (WWAN) air interface and wherein the second interface comprises a wireless local area network (WLAN) air interface.

4. The method of claim 1 wherein the first information comprises one or more cellular paging messages and wherein the second information comprises a plurality of packet data units.

5. The method of claim 2 wherein the first air interface is selected for data requiring relatively low bandwidth in transmitting or receiving and wherein the second air interface is selected for data requiring a higher bandwidth in transmitting or receiving.

6. The method of claim 1 wherein the first air interface comprises a code division multiple access (CDMA) air interface and wherein the second air interface comprises an orthogonal frequency division multiplex (OFDM) air interface.

7. The method of claim 2 wherein selecting the first or second air interface is controlled, at least in part, by an application server associated with a network access station.

8. An apparatus for use in a wireless network, the apparatus comprising:
a processing circuit adapted to enable the apparatus to transmit or receive first information using a first air interface and transmit or receive second information using a second air interface different than the first interface while maintaining connection with the first air interface.

9. The apparatus of claim 8 further comprising:
at least one radio frequency (RF) interface coupled to the processing circuit.

10. The apparatus of claim 8 wherein the apparatus comprises at least a portion of a mobile station.

11. The apparatus of claim 8 wherein the apparatus comprises at least a portion of a network access station.

12. The apparatus of claim 8 wherein the processing circuit is further adapted to select the first or second air interface based on an amount of information to be transmitted or received.

13. The apparatus of claim 8 wherein the first air interface comprises a wireless wide area network (WWAN) air interface and wherein the second interface comprises a wireless local area network (WLAN) air interface.

14. The apparatus of claim 8 wherein the first information comprises one or more cellular paging messages and wherein the second information comprises a plurality of packet data units.

15. The apparatus of claim 8 wherein the first air interface is selected for transmitting or receiving a first volume of data and wherein the second air interface is selected for transmitting or receiving a second, higher volume of data.

16. The apparatus of claim 8 wherein the first air interface comprises a spread spectrum air interface and wherein the second air interface comprises an orthogonal frequency division multiplex (OFDM) air interface.

17. The apparatus of claim 8 wherein the first or second air interface is selected based on an application server associated with a network access station.

18. The apparatus of claim 9 further comprising at least two antennas coupled to the RF interface to provide multiple input multiple output (MIMO) capability.

19. The apparatus of claim 8 further comprising a memory in communication with the processing circuit and operative to store an application program for web browsing.

20. A system comprising:
a processing circuit configured to transmit or receive first information using a first air interface and transmit or receive second information using a second air interface different than the first interface while maintaining a link through the first air interface; and
a memory in communicaton to the processing circuit, the memory storing a web browser application program adapted to use the second information for displaying or updating a web page.

21. The system of claim 20 wherein the system comprises a mobile station.

22. The system of claim 21 wherein use of the first and second air interfaces is selected by a server associated with a network access station.

23. The system of claim 22 wherein use of the first and second air interfaces is selected based on an amount of information to be transmitted or received.

24. The system of claim 20 wherein the first air interface comprises a wireless wide area network (WWAN) air interface and wherein the second interface comprises a wireless local area network (WLAN) air interface.

25. The system of claim 20 wherein the first information comprises one or more cellular paging messages and wherein the second information comprises a plurality of packet data units.

26. The system of claim 20 wherein the first air interface comprises a spread spectrum air interface and wherein the second air interface comprises an orthogonal frequency division multiplex (OFDM) air interface.
